(19) United States
(12) Patent Application Publication
(10) Pub. No.: US 2011/0224875 A1
(43) Pub. Date: Sep. 15, 2011

(54) Biometric Application of a Polymer-based Pressure Sensor

(76) Inventors: Mark A. Cuddihy, New Boston, MI (US); Manoharprasad K. Rao, Novi, MI (US); Susan M. Young, Canton, MI (US)

(21) Appl. No.: 12/720,707

(22) Filed: Mar. 10, 2010

(51) Int. Cl. G06F 7/00; H04N 7/18; B62D 6/00; B60W 10/00

(52) U.S. Cl. 701/42; 348/77; 701/1; 348/E07.085

(57) ABSTRACT

The invention is a control system for adjusting at least one vehicle system in a plurality of vehicle systems comprising at least one polymer-based biometric sensor positioned proximate a driver for monitoring at least one vital sign of a driver of the vehicle and configured to produce data in response to changes in the at least one vital sign. The system also comprises at least one camera system positioned to view the driver. A first processing system is configured to receive sensor data and input collected by the camera system to determine a biometric state of the driver. The biometric state of the vehicle driver is then used to determine an adjustment setting for the at least one vehicle system thereby controlling the vehicle system in response to the adjustment setting in accordance with the determined biometric state of the vehicle driver.

### TECHNICAL FIELD

This invention relates generally to vehicle occupant monitoring and more particularly to monitoring components of a vehicle driver's biometric state and adjusting various vehicle system functions in response to the driver's biometric state.

### BACKGROUND

A driving experience may be enhanced by the systems of the vehicle itself, such as the steering, suspension, transmission, and safety systems. These systems are controlled as a function of the vehicle in that various vehicle parameters are sensed during the vehicle operation and are used to determine the performance and function of each such system. A big part of the driving experience is safety performance which exercises the goal of minimizing accidents and occupant injury. The driving experience, however, may be expanded beyond minimizing accidents and occupant injury that may result from such accidents. The driving experience may be enhanced such that a driver's wellness and emotions are taken into consideration, going beyond only the personal safety of the occupant. The driving experience is already controlled by many vehicle systems that use information gathered from sensors that provide information about the vehicle itself. Furthermore, visual indicators, such as cameras, may be used to assess how a driver may be affected by various external vehicle conditions that exist around the driver.

Control systems for vehicles command various actuators of the motor vehicle to perform specific tasks in response to data supplied by various sensors on the vehicle that are positioned to collect useful information about the vehicle's movements and responses with respect to the road and environment. Control systems may include traction control systems, anti-lock braking systems, stability control systems, steering systems, among others too numerous to be listed herein. Each control system serves a particular purpose to be carried out when certain information is sensed by the vehicle. Additionally, each control system may affect a vehicle driver to a certain degree.

The vehicle driver is a critical component to the control systems on a vehicle and is the one most affected by the driving experience. The driver's response to a particular driving condition, such as an obstacle in the road or an icy road, may be limited by the vehicle's reaction to action taken by the driver. For example, if the driver is less than perfectly alert or if his or her physical condition is stressed, the driver may be slow in responding to and acting on the particular driving condition. Currently, the vehicle control systems do not communicate with the driver in a way that takes into consideration the driver's biometric state as a factor in commanding various actuators on the motor vehicle.

Other systems within the vehicle, that do not directly affect the vehicle performance, but affect the travel experience of the vehicle driver such as an entertainment system, a climate control system, and an interior lighting system, may also have an effect on the vehicle driver's biometric state. These systems typically are controlled by the vehicle driver only, so if the driver's state changes and the driver does not adjust the system settings on his or her own, it may adversely affect the drivers action/reaction time to external driving conditions. Ideally, the biometric state of the driver may be considered and applied to systems that directly affect the driver's biometric state. However, the biometric state of the driver is typically not considered in making automated adjustments to the vehicle systems that affect the driver operation and thus the driving conditions of the vehicle.

While various systems are adapted to determine a driver's load in order to warn the driver of an impending situation, there is a need to incorporate the biometric state of the vehicle driver as a factor. There is also a need to adjust and modify the vehicle systems, including control systems, in response to the vehicle driver's biometric state. There is a further need to adjust and modify the vehicle systems, including control systems, to affect and improve the vehicle driver's biometric state.

### SUMMARY

One aspect of the invention is a control system for adjusting at least one vehicle system in a plurality of vehicle systems comprising at least one polymer-based biometric sensor for monitoring at least one vital sign of a driver of the vehicle, the at least one polymer-based biometric sensor positioned proximate the driver, the at least one polymer-based biometric sensor configured to produce data in response to changes in the at least one vital sign. The system also comprises at least one camera system positioned to view the driver, the at least one camera system configured to monitor at least one external characteristic of the driver. A first processing system communicatively coupled to the at least one polymer-based sensor and the at least one camera system is configured to receive sensor data and input collected by the at least one camera system and determine a biometric state of the driver, a second processing system communicatively coupled to the first processing system is configured to receive the biometric state of the vehicle driver and determine an adjustment setting for the at least one vehicle system and a vehicle data bus communicates the adjustment setting to the at least one vehicle system thereby controlling the vehicle system in response to the adjustment setting thereby altering a response of each vehicle system in accordance with the determined biometric state of the vehicle driver.

In another aspect of the present invention, a method is provided for controlling a vehicle system having the steps of positioning at least one polymer-based biometric sensor and at least one camera system proximate a vehicle driver, monitoring at least one vital sign of the vehicle driver with the at least one polymer-based biometric sensor and monitoring at least one external characteristic of the vehicle driver with the at least one camera system, collecting data relating to changes in the at least one vital sign of the vehicle driver and communicating the collected data to a processing unit, collecting data relating to visual image data associated with the external characteristic of the vehicle driver and communicating the collected data to the processing unit, collecting data relating to external vehicle movements and communicating the collected data to the processing unit, processing the collected data in the processing unit to determine a biometric state for the vehicle driver, processing the biometric state of the vehicle driver and a plurality of predetermined vehicle parameters to determine an adjustment setting for at least one of a plurality of vehicle systems wherein an adjustment setting is determined for each of a corresponding vehicle system in the plurality of vehicle systems, and controlling at least one vehicle system in the plurality of vehicle systems with the adjustment setting corresponding to that vehicle system.

### DESCRIPTION OF DRAWINGS

FIG. 1 is a cross-sectional view of a driver within a vehicle having a biometric control system of the present invention;

FIG. 2 is cross-sectional view of a biometric sensor that is part of the biometric control system of the present invention; and

FIG. 3 is a block diagram of the biometric control system of the present invention.

Elements and steps in the figures are illustrated for simplicity and clarity and have not necessarily been rendered according to any particular sequence. For example, steps that may be performed concurrently or in a different order are illustrated in the figures to help improve understanding of embodiments of the present invention.

### DESCRIPTION OF INVENTION

While various aspects of the present invention are described with reference to a particular illustrative embodiment, the invention is not limited to such embodiments, and additional modifications, applications, and embodiments may be implemented without departing from the scope of the present invention. In the figures, like reference numbers will be used to illustrate the same components. Those skilled in the art will recognize that the various components set forth herein may be altered without varying from the scope of the inventive subject matter.

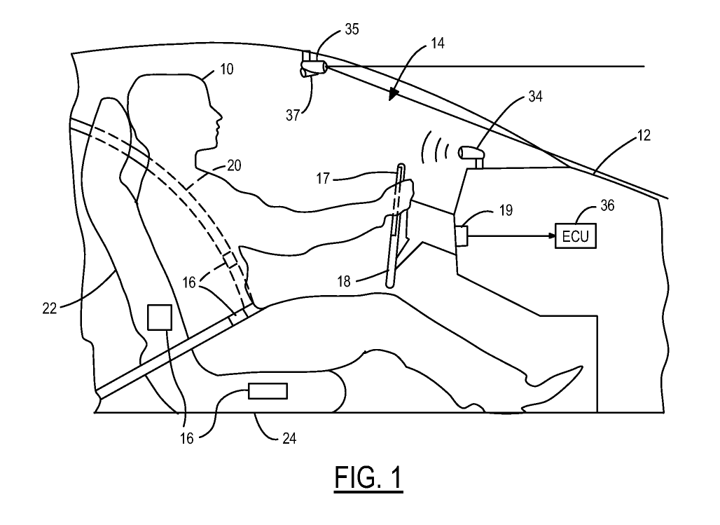

FIG. 1 is a cross-sectional view of a vehicle driver 10 within a vehicle 12 having a biometric control system 14 of the present invention. Biometric sensors 16, 17 are strategically placed within components of the vehicle that are in direct or indirect contact with the vehicle driver 10 and sense vital signs associated with the driver 10. Vital signs may include respiration rate, heart rate, and skin temperature. Respiration rate and heart rate, for example, may be sensed through a sensor 16 located in the seat cushion behind the driver's back or through a sensor 16 located in a seat bottom under the driver's buttocks and thighs. The driver's respiration rate may also be sensed by the sensor 16 located in a shoulder and/or lap belt. A gripping force and/or a skin temperature may be detected by one or more sensors 17 located in a steering wheel.

In an exemplary embodiment of the present invention, a steering wheel 18 may have one or more biometric sensors 17 strategically placed in locations that would indirectly contact the hands of the driver, sensing gripping force and/or skin temperature. The steering wheel 18 typically also has a sensor 19 associated with the steering system for sensing a steering rate which will be discussed later herein. A seat belt 20, or other restraint device, may also have one or more biometric sensors 16 strategically placed in locations where they would indirectly contact the torso of the driver. A seat back 22, or seat bottom 24, may also contain one or more biometric sensors 16 located such that they indirectly contact the driver. These strategically placed biometric sensors 16, 17 indirectly collect data relating to vital signs of the driver such as a respiration rate, heart rate and other physiological aspects of the driver. The contact is indirect which means the sensors are not in direct contact with the vehicle driver. The sensors are embedded in articles that are in direct contact with the driver.

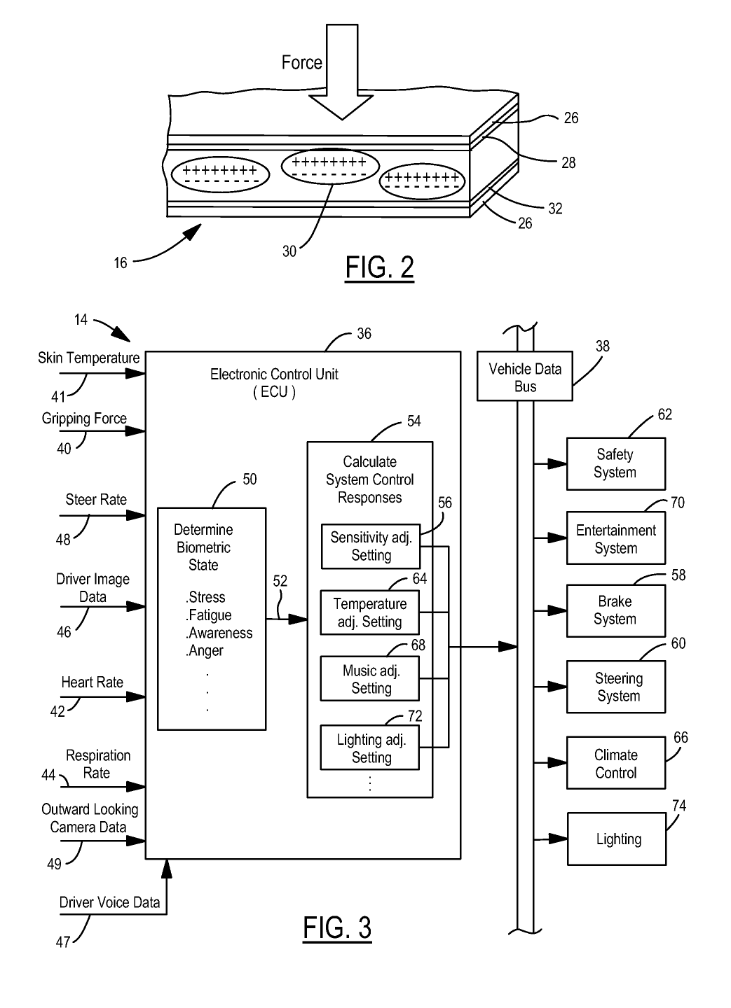

According to the present invention, the sensed and collected data may be used to determine a driver's biometric state. Moods, feelings, emotions may be inferred from the biometric state of the driver, and the vehicle control systems and other systems may be adjusted accordingly in response to the determined biometric state. Heartbeat and respiration may be measured by the biometric sensors 16 placed in the seat back cushion and/or seat bottom cushion and/or the seat belt. The biometric sensors 16 are polymer-based sensors that detect changes in heartbeat, respiration and movement. The sensors 16 sense transients, or changes, in force. No voltage or signal is output by the sensor under steady state conditions. This limits the amount of data that is stored in memory and processed by present invention. The sensors 16 are thermally stable at temperatures encountered in vehicle applications and are capable of sensing minute changes in pressure, due to events such as movements in arteries during a heartbeat. FIG. 2 shows a cross section of such a biometric sensor 16. A shield layer 26 is subject to the forces applied to the sensor. The shield layer 26 protects a first electrode layer 28. An electrically charged polypropylene layer 30 is sandwiched between the first electrode layer 28 and a second electrode layer 32. The second electrode layer 32 is also protected by a shield layer 26. The electrode layers may be aluminum or other suitable material. A force, such as the minute change in pressure caused by a heartbeat or respiration, will cause a change in a voltage output by the sensor 16. The subtle voltage changes are used as inputs to an electronic control unit to be discussed in detail hereinafter.

One or more biometric sensors 17 placed on the steering wheel may measure driver skin temperature and steering wheel gripping force. The skin temperature sensor may be a temperature sensor composed of a thermo-resistive effect, a thermoelectric effect, a piezoelectric effect, an optical transducer or a semi-conductive transducer. A typical semi-conductor temperature sensor may be a good choice for this application due to its good linear response over a wide range of temperatures. Biometric sensors 17 may also include sensors for measuring wheel gripping forces. Some commonly used force sensors include piezoresistive sensors, piezoelectric sensors, and strain gauges. A piezoresistive tactile force sensor may be used for steering wheel gripping force measurements.

Other devices and/or sensors may also be present in the vehicle to collect data relating to other external characteristics related to the vehicle driver. One known method for collecting such data about a driver is a camera 34 located in the vehicle. The camera 34 may collect image data that relates to the vehicle driver's eyes, head movements, and the like. Whether the driver's eyes are open, blinking, closed, or focused may be valuable data relating to the driver. Even pupil size may be relevant to the driver's biometric state. Further, the driver's head movements, or lack thereof, may also be relevant to the determination of the driver's biometric state. The vehicle may also be equipped with a forward or rearward looking camera for monitoring vehicle external surroundings. A typical forward looking camera 35 may be mounted behind the vehicle rearview minor and may monitor various road signs and lane markers. Various algorithms associated with vehicle active safety systems assess the driver's state of awareness using data from the camera 35. The vehicle may also be equipped with a microphone 37, such as the microphone used with driver-to-vehicle communication systems. The microphone 37 may acquire driver voice commands and other speech elements and may provide them to a voice analysis system to assess the driver's emotional and physiological state.

Referring now to FIG. 3, a block diagram of a biometric control system 14 of the present invention is shown. The biometric sensors 16, 17 sense and gather changes that are input to an electronic control unit (ECU) 36 where the changes are interpreted and used to provide data inputs. The sensed data may include, but is not limited to, changes in a gripping force 40, skin temperature 41, a heart rate 42 and a respiration rate 44. Other inputs that also are representative of a vehicle driver's biometric state may be provided by other devices that monitor the driver and/or condition inside and outside of the vehicle, such as the camera devices 34, 35 and microphone 37. Such inputs may include, but are not limited to, a driver visual image data 46 including, eye movements, or lack thereof, head movements, or lack thereof, driver voice analysis data and the like. A steer rate input 48 may also be provided to the ECU from the sensor that is part of the steering system.

The inputs relating to driver biometric state, i.e., steering wheel gripping force 40, skin temperature 41, steer rate 48, driver visual image data 46, respiration rate 44, heart rate 42, driver voice analysis input 47 and outward looking camera inputs 49, are sent to the ECU 36 for analyzing and processing. The processing is done in the ECU, using algorithms, to determine a biometric state 50 of the driver. The biometric state includes, but is not limited to, any or all of the following factors to some degree; a stress level, a fatigue level, driver awareness level, an anger level, and the like. The biometric state 50 is then used as an input 52 in another level of processing in the ECU to calculate system control responses 54 which may be sent as control commands to various vehicle systems, including, but not limited to sensitivity settings 56 for brake system 58, steering system 60, and safety systems 62, a temperature adjustment setting 64 for a climate control system 66, a music adjustment setting 68 for an entertainment system 70, and a lighting adjustment setting 72 for a lighting system 74. The ECU 36 is connected to a vehicle bus 38 that is used to communicate each of the adjustment settings 56, 64, 68, 72 to the appropriate vehicle system 62, 70, 58, 60, 66, and 74. While two levels of processing are described herein, it should be noted that each level of processing may be performed in the same ECU 36.

The polymer-based biometric sensors 16 are strategically placed in multiple locations 18, 20, 22, and 24 from which they can sense and collect data concerning the driver's 10 respiration rate 44 and heart rates 42 which are representative of the driver's physiological state. The ECU 36 may calculate heart rate 42 and respiration rate 44 by analyzing the response of sensors, such as those sensors 16 in the seat bottom 24, seat back 22, and seat belt 20. The redundancy and data from multiple sensors 16 may add to the reliability of the sensed data. The sensed data is combined logically with other available information, such as the driver visual image data monitoring camera input 46, steering rate sensor input 48, outward looking camera data input 49, steering wheel sensor inputs 40, 41 and microphone data input 47 where it is interpreted to determine a biometric state 50 of the driver 10. The ECU 36 then uses the biometric state 50 data and logically develops control adjustments 56, 64, 68, 72 for various vehicle systems 58, 60, 62, 66, 70, and 74. The control adjustments are sent to each corresponding vehicle system so that the systems may be adjusted to compensate for or improve the determined biometric state.

According to the present invention, the control adjustments not only modify a control system of the vehicle, but may result in a modification or improvement of the driver's biometric state. For example, vehicle steering and braking sensitivity may be adjusted to compensate for a stress level of the driver. A more responsive steering or braking may alleviate stress in the driver. Music volume and song selection may be modified to fit an emotional status of the driver. A calmer music selection may soothe the driver, thereby relieving anger or stress. An upbeat music selection may increase happiness. Climate control systems may be adjusted to respond to a physical condition of the driver, making the driver more comfortable, thereby relieving stress and affecting mood.

It should be noted that the processing performed in the ECU 36 is not attempting to determine the driver's cognitive load or ability to react to a driving condition. The biometric state is merely being noted and various control systems surrounding the driver are adjusted in accordance with that state in an attempt to improve the driver's biometric state. Driver stress, anger, and fatigue affect reaction time, attention, and the driver's longevity. Improvements in driver wellness not only improve driver safety, and increase longevity, but improve many other facts of one's life producing personal safety and wellness inside and outside of the vehicle. According to the present invention, the determination of a driver's biometric state is being made for the purpose of determining and applying adjustments to various control systems on the vehicle in an attempt to ease, or improve, the driver's biometric state, and thus the driving experience, which ultimately may result in improved driving performance and improved driver wellness.

There are several advantages associated with the polymer-based biometric sensors that are used according to the present invention. The sensors are extremely cost effective and highly reliable, yet maintain a high level of sensitivity. The polymer-based biometric sensors have been applied in the healthcare industry for the purpose of monitoring patients and vulnerable populations such as infants, children and older adults. These sensors are used to detect changes in the driver's biometric by monitoring vital signs in a non-intrusive manner. As an example of patient monitoring purposes, the sensors have been placed under beds. The signal processing algorithms and electronics associated with these sensors are well developed and relatively inexpensive.

The data storage and processing requirements for monitoring the driver's biometric state using polymer-based biometric sensors may be easily accommodated in any one of numerous ECU's already in use on the vehicle such as a body control module, a restraint control module, a chassis control module, etc. The small size of the biometric sensors enables packaging in existing components, such as seat cushions and seat belts, which reduces the effort required to integrate the sensors into the vehicle's interior. The passive nature of the polymer-based biometric sensor is another advantage in that it alleviates any concerns regarding long-term exposure of the driver to sensing signals such as exposure to radio waves that are associated with known technologies such as ultrasonic pulses and radar waves. These features result in a simplified system and method for monitoring a vehicle driver and effecting changes to the vehicle systems to improve the driver's biometric state.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Any control systems may be implemented with a filter to minimize effects of signal noises. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

What is claimed is:

1. A control system for adjusting at least one vehicle system in a plurality of vehicle systems comprising:
at least one polymer-based biometric sensor for monitoring at least one vital sign of a driver of the vehicle, the at least one polymer-based biometric sensor positioned proximate the driver, the at least one polymer-based biometric sensor configured to produce data in response to changes in the at least one vital sign;
at least one camera system positioned to view the driver, the at least one camera system configured to monitor at least one external characteristic of the driver;
a first processing system communicatively coupled to the at least one polymer-based sensor and the at least one camera system, the first processing system configured to receive sensor data and input collected by the at least one camera system and determine a biometric state of the driver;
a second processing system communicatively coupled to the first processing system, the second processing system configured to receive the biometric state of the vehicle driver and determine an adjustment setting for the at least one vehicle system;
a vehicle data bus for communicating the adjustment setting to the at least one vehicle system thereby controlling the vehicle system in response to the adjustment setting thereby altering a response of each vehicle system in accordance with the determined biometric state of the vehicle driver.

2. The system as claimed in claim 1 wherein the control system further comprises a steering rate sensor communicatively coupled to a steering column on the vehicle, the steering rate sensor configured to monitor a steering rate initiated by the vehicle driver and provided as an input to be used by the first processing system.

3. The system as claimed in claim 1 wherein the biometric state of the vehicle driver further comprises at least one characteristic selected from the group consisting of: a stress level, a fatigue level, an awareness level, and an anger level.

4. The system as claimed in claim 1 wherein the adjustment setting further comprises at least one adjustment setting selected from the group consisting of: a sensitivity adjustment setting, a temperature adjustment setting, a music adjustment setting, and a lighting adjustment setting.

5. The system as claimed in claim 1 wherein the plurality of vehicle systems further comprises at least one vehicle system selected from the group consisting of: a safety system, an entertainment system, a brake system, a steering system, a climate control system, and a lighting system.

6. The system as claimed in claim 1 further comprising a biometric sensor positioned in a steering wheel and communicatively coupled to the first processing system.

7. The system as claimed in claim 1 wherein the at least one polymer-based biometric sensor is positioned in a seat bottom cushion.

8. The system as claimed in claim 1 wherein the at least one polymer-based biometric sensor is positioned in a seat back cushion.

9. The system as claimed in claim 1 wherein the at least one polymer-based biometric sensor is positioned in a seat belt.

10. The system as claimed in claim 1 wherein the at least one camera system further comprises an interior camera.

11. The system as claimed in claim 1 wherein the at least one camera system further comprises an exterior camera.

12. The system as claimed in claim 1 wherein the at least one camera system further comprises a microphone.

13. A sensor networking system for vehicle system control, the networking system comprising:
a plurality of sensor systems positioned throughout a vehicle, at least one sensor in the plurality of sensor systems comprising a polymer-based biometric sensor, a steering rate sensor and a camera;
a processing system communicatively coupled to the plurality of sensor systems, the processing system configured to receive data from the plurality of sensor systems and determine a biometric state of the vehicle driver and determine a system control response based on the biometric state of the vehicle driver;
a plurality of vehicle systems communicatively coupled to the processing system and configured to receive the control system response from the processing system and control the vehicle system accordingly.

14. The system as claimed in claim 13 wherein the control system response further comprises at least one control system response selected from the group consisting of: a sensitivity adjustment setting, a temperature adjustment setting, a music adjustment setting, and a lighting adjustment setting

15. The system as claimed in claim 14 wherein the plurality of vehicle systems further comprises at least one vehicle system selected from the group consisting of: a safety system, an entertainment system, a brake system, a steering system, a climate control system, and a lighting system.

16. The system as claimed in claim 13 wherein the plurality of sensor systems further comprises an interior camera, a forward-looking camera, and a microphone.

17. The system as claimed in claim 13 wherein the polymer-based biometric sensor is positioned in at least a seat, a seat belt device, and at least one biometric sensor is positioned in a steering wheel.

18. A method of controlling a vehicle system comprising:
positioning at least one polymer-based biometric sensor and at least one camera system proximate a vehicle driver;
monitoring at least one vital sign of the vehicle driver with the at least one polymer-based biometric sensor and monitoring at least one external characteristic of the vehicle driver with the at least one camera system;
collecting data relating to changes in the at least one vital sign of the vehicle driver and communicating the collected data to a processing unit;
collecting data relating to image data associated with the external characteristic of the vehicle driver and communicating the collected data to the processing unit;
collecting data relating to external vehicle movements and communicating the collected data to the processing unit;
processing the collected data in the processing unit to determine a biometric state for the vehicle driver;
processing the biometric state of the vehicle driver and a plurality of predetermined vehicle parameters to determine an adjustment setting for at least one of a plurality of vehicle systems wherein an adjustment setting is determined for each of a corresponding vehicle system in the plurality of vehicle systems;
controlling at least one vehicle system in the plurality of vehicle systems with the adjustment setting corresponding to that vehicle system.

19. The method as claimed in claim 18 wherein the step of positioning at least one polymer-based biometric sensor further comprises positioning the sensor in a seat.

20. The method as claimed in claim 18 wherein the step of positioning at least one polymer-based biometric sensor further comprises positioning the sensor in a seat belt device.

21. The method as claimed in claim 18 further comprising the step of positioning at least one biometric sensor in a steering wheel device.

22. The method as claimed in claim 18 wherein the step of positioning at least one polymer-based biometric sensor further comprises positioning a sensor in each of a seat back, a seat bottom, a seat belt device and positioning at least one biometric sensor in a steering wheel device.

23. The method as claimed in claim 18 wherein the step of positioning at least one camera system further comprises positioning an interior-based camera for recording driver visual image data.

24. The method as claimed in claim 23 wherein the step of positioning at least one camera system further comprises positioning a forward-looking camera for recording the vehicle movements.

25. The method as claimed in claim 23 wherein the step of positioning at least one camera system further comprises positioning a microphone inside the vehicle for recording driver voice data.

26. The method as claimed in claim 18 wherein the step of controlling at least one vehicle system further comprises controlling at least one system from the group consisting of: a safety system, an entertainment system, a brake system, a steering system, a climate control system and a lighting system.

27. The method as claimed in claim 18 wherein the step of processing the collected data in the processing unit to determine a biometric state for the vehicle driver further comprises a biometric state determined from the group consisting of: stress, anger, fatigue, awareness, or a combination of any or all biometric states.
